(19) United States
(12) Patent Application Publication
(10) Pub. No.: US 2018/0160655 A1
(43) Pub. Date: Jun. 14, 2018

(54) PET TAG HOLDER

(71) Applicant: Monika Theresia Geier, Kelowna (CA)

(72) Inventor: Monika Theresia Geier, Kelowna (CA)

(21) Appl. No.: 15/379,238

(22) Filed: Dec. 14, 2016

(51) Int. Cl. A01K 27/00; A01K 11/00

(52) U.S. Cl. CPC A01K 27/006; A01K 11/00; A01K 27/001

(57) ABSTRACT

Disclosed is an apparatus and method or displaying and attaching a tag to a pet collar. The apparatus comprises a front planar member extending between first and second edges and between top and bottom edges and a rear planar member extending between first and second edges and between top and bottom edges. The apparatus further comprises at least one fastener for mounting the front and rear planar members to a pet collar wherein the front and rear planar members are sized to receive and contain the tag therebetween. The method further comprises inserting the tag between the front and rear planar members and fastening the front and rear planar members to a pet collar so as to contain the tag therebetween.

### BACKGROUND OF THE INVENTION

### 1. Field of Invention

The present invention relates generally to pet tags, and in particular to a holder adapted to secure and attach a tag to a collar.

### 2. Description of Related Art

Pets frequently carry tags on them for identification, licensing or other purposes. Pets may include dogs, cats, horses, cattle and other animals. In many jurisdictions, pet owners are required to license and vaccinate their pet, and they provide proof of compliance with tags that are to be maintained on the pet. Pet owners may also desire to attach tags with identification information for cases when their pet may become lost. Frequently, these tags are attached to a collar worn around the pet's neck, although tags may also be attached to any location on the pet, including harnesses, bridles, lead ropes or leashes, as well.

Tags may be constructed using metal or rigid plastic, to withstand vigorous pet activity. Typically, when these tags are attached to a neck collar by way of a hole through the tag, with a ring inserted into the hole and attached to the collar, the tags hanging freely from the collar. When tags hang from a collar, they may be prone to catching on items in the environment, causing the tag to disengage from the collar, or causing injury to the pet. As a tag wears, the hole can increase in size, and eventually fail, breaking off of the collar. Additionally, it is frequently necessary to attach multiple tags to a collar simultaneously, resulting in the tags contacting each other as the pet moves, causing undesirable noise and extra wear to tags.

Attempts have been made to silence undesirable noise caused by multiple pet tags hitting against one another, such as disclosed in U.S. Pat. No. 6,367,426 B1 to Schaible and U.S. Pat. No. 6,735,894 B2 to Crusenberry et al. Such devices, however, hang from a collar, and are therefore prone to catch on items in the environment, with disadvantages as detailed above.

In prior art, pet tag holders have been disclosed that loop around an existing collar, such that the tag holder is not permanently mounted to the collar and thus the collar may slide therein. Examples include United States Patent Application No. 2007/0283901 by LeVally and U.S. Pat. No. 4,739,566 issued to Smith.

United States Patent Application No US2007/0074678 A1 to Fritschler discloses a pet tag holder incorporated with a collar. This device relies on a flap to secure the tag within the holder, which can catch on objects in the environment, potentially causing injury to the pet.

Some prior art pet tag holders mount to a collar, but require custom tags to fit therein. Examples include U.S. Pat. No. 4,137,660 issued to issued to Dettmann et al. and U.S. Pat. No. 3,585,743 issued to Jeffers.

### SUMMARY OF THE INVENTION

According to a first embodiment of the present invention there is disclosed an apparatus for displaying and attaching a tag to a pet collar comprising a front planar member extending between first and second edges and between top and bottom edges and a rear planar member extending between first and second edges and between top and bottom edges. The apparatus further comprises at least one fastener for mounting the front and rear planar members to a pet collar wherein the front and rear planar members are sized to receive and contain the tag therebetween.

The front and rear planar members may be flexible. The front and rear planar members may be formed of a material selected from a group consisting of leather, composite fabrics, and plastics.

The front planar member may include a display opening therethrough adapted to display the tag therethrough. The front and rear planar members may be joined to each other proximate to at least one of the first, second, top and bottom edges, wherein at least one edge is open.

The front and rear planar members may include at least one mounting hole extending therethrough. The at least one mounting hole may comprises two mounting holes. The two mounting holes may be spaced apart by a distance sufficient to receive the tag therebetween. The at least one mounting hole may comprise one mounting hole at a location proximate to one of the first, second, top and bottom edges such that it is spaced apart a distance from an opposite edge to receive the tag therebetween.

The at least one fastener may comprise screw and post fasteners. The screw and post fasteners may be passed through the at least one mounting hole.

The apparatus may further include a transparent planar member extending between the first and second edges and between the top and bottom edges, located between the front planar member and the tag. The transparent member may be secured to a rear surface of the front planar member. The transparent planar member may be formed of a material selected from a group consisting of plastic and acrylic.

According to a further embodiment of the present invention there is disclosed an apparatus for displaying and attaching a tag to an animal comprising a collar, securable around the neck of an animal, a front planar member extending between first and second edges and between top and bottom edges and a rear planar member extending between first and second edges and between top and bottom edges. The apparatus further comprises at least one fastener for mounting the front and rear planar members to a pet collar wherein the front and rear planar members are sized to receive and contain the tag therebetween.

The front planar member may be co-formed with the collar. The rear planar member may be co-formed with the collar. The rear planar member may include a slot therethrough adapted to allow the tag to pass therethrough. The slot may be formed at a location proximate to one of the first, second, top and bottom edges such that it is spaced apart a distance from an opposite edge to receive the tag therebetween.

According to a further embodiment of the present invention there is disclosed a method for displaying and attaching a tag to a pet collar comprising providing a front planar member extending between first and second edges and between top and bottom edges and providing a rear planar member extending between first and second edges and between top and bottom edges. The method further comprises inserting the tag between the front and rear planar members and fastening the front and rear planar members to a pet collar so as to contain the tag therebetween.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a tag holder apparatus for displaying and attaching a tag on a collar according to a first embodiment of the invention.

FIG. 2 is a plan view of the tag holder of FIG. 1.

FIG. 3 is a cross sectional view of the tag holder and collar of FIG. 1, taken along the line 3-3.

FIG. 4 is a plan view of the tag holder of FIG. 1 according to a further embodiment of the invention.

FIGS. 5a-5f are several plan views of the tag holder of FIG. 1 according to further embodiments of the invention.

FIG. 6 is a perspective view of the tag holder of FIG. 1 according to a further embodiment of the invention.

FIG. 7 is an exploded perspective view of the tag holder of FIG. 1 according to a further embodiment of the invention.

### DETAILED DESCRIPTION

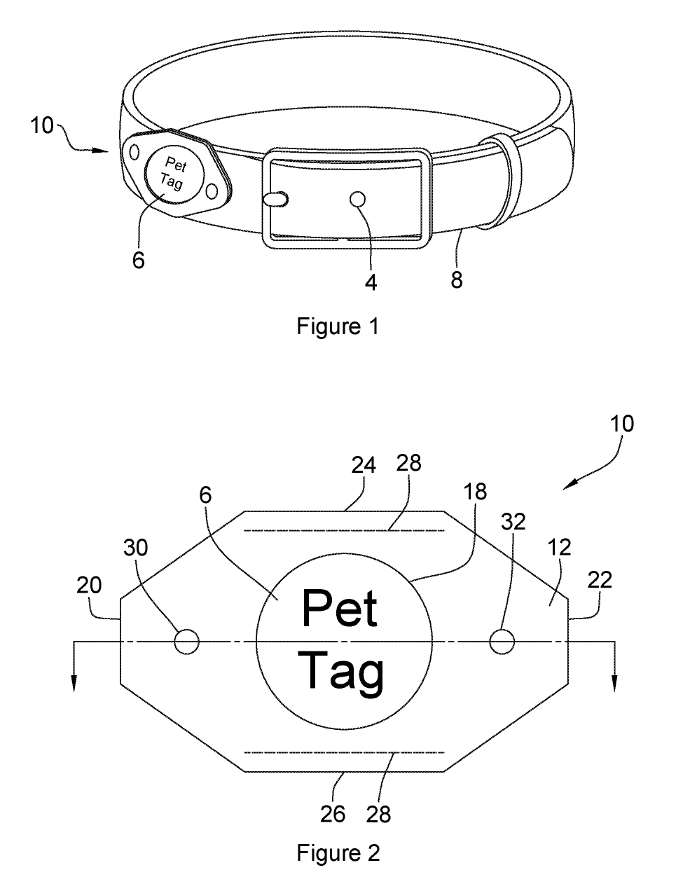

Referring to FIGS. 1, 2 and 3, an apparatus for attaching and displaying tags on a collar according to a first embodiment of the invention is shown generally at 10. The tag holder 10 is mounted on a pet collar 8, with at least one tag 6 retained therein, as will be described more fully below.

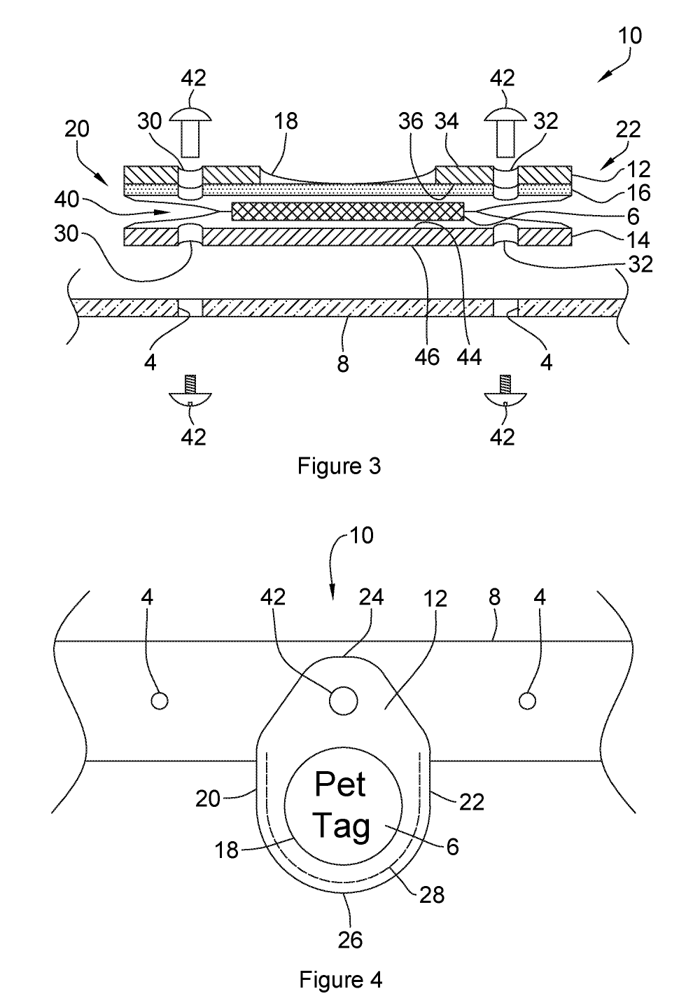

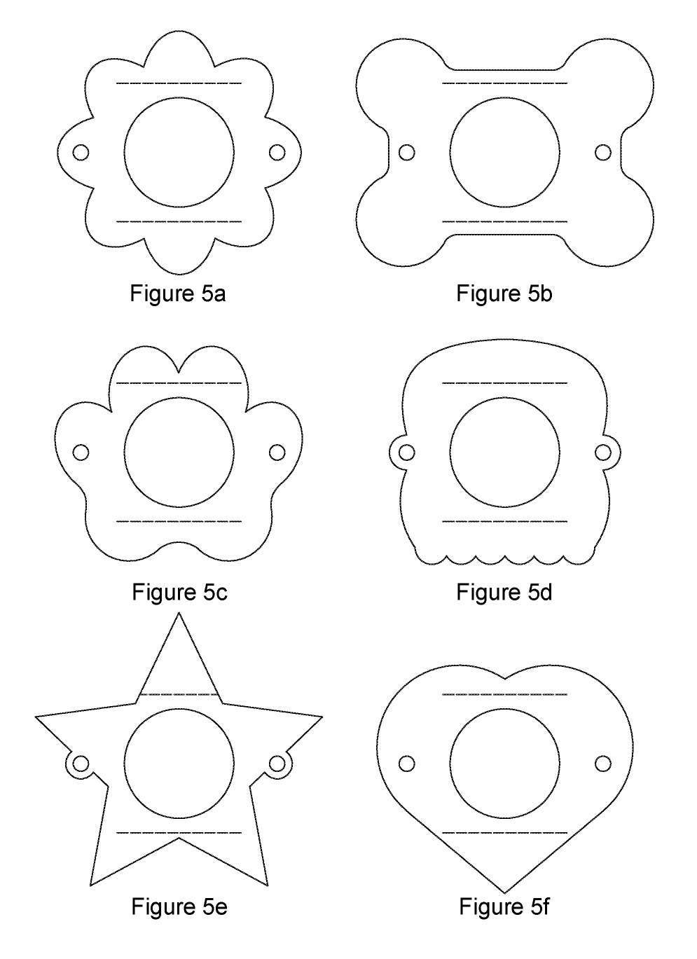

The tag holder 10 comprises front and rear planar members 12 and 14, respectively, with an optional transparent planar member 16 therebetween, as shown in FIG. 3. The front, rear and transparent planar members 12, 14 and 16 extend between first and second edges, 20 and 22, respectively, and between top and bottom edges, 24 and 26, respectively. Although the front, rear and transparent planar members 12, 14 and 16 are illustrated as octagonal, it will be appreciated that other shapes may be used as well, such as, by way of non-limiting example, rectangular, oval, obround, or any suitable decorative shape, as illustrated by way of non-limiting example in FIGS. 5a through 5f. The front and rear planar members 12 and 14 may be formed of any suitable sturdy, flexible material, such as, by way of non-limiting example, leather, composite fabrics, plastics or the like. It will be appreciated that leather materials may include deerskin, cowhide, lambskin or any other suitable leather as is commonly known and having thicknesses selected to provide sufficient strength and workability. By way of non-limiting example, it has been found that leather thicknesses between 2 to 4 oz (0.8 to 1.6 mm) has been useful, although it will be appreciated that other thicknesses may be useful as well. The material for forming front and rear planar members 12 and 14 may also be formed to have sufficient stability to maintain their shape. The transparent planar member 16 may be formed of any suitable material, such as plastic or acrylics having a thickness suitable to secure the tag 6 therebehind. In practice, it has been found that a thickness of between 1/64 and 3/64 inch (0.4 and 1.2 mm) may be useful, although it will be appreciated that other thicknesses may be useful as well.

The front planar member 12, having front and rear surfaces 34 and 36, respectively, includes an opening 18 therethrough, centred thereon, sized to display a tag 6 therethrough. Although the opening 18 is illustrated as circular, it will be appreciated that other shapes may be used as well, such as, by way of non-limiting example, square or oval. The rear planar member 14 includes front and rear surfaces 44 and 46. The front, rear and transparent planar members 12, 14 and 16 are secured together proximate to the top and bottom edges 24 and 26 by any suitable method, such as, by way of non-limiting example, adhesives, stitching 28 (as illustrated), fasteners or the like. Optionally, the transparent planar member 16 may be additionally secured to the rear surface 36 of the front planar member 12 with an adhesive therebetween.

The front, rear and transparent planar members 12, 14 and 16 include first and second mounting holes, 30 and 32, respectively, therethrough proximate to the first and second edges 20 and 22. The mounting holes 30 and 32 may be sized in the range of ⅛″ to ¼″ (3 mm to 6 mm), by way of non-limiting example, and are spaced apart such as to permit a tag 6 to be received therebetween, as illustrated in FIG. 3. The mounting holes 30 and 32 may be spaced apart to match the spacing of collar holes 4, although it may be appreciated that additional collar holes 4 may be added to a pet collar 8 by any means as is commonly known to permit the tag holder 10 to be mounted to the pet collar 8.

To insert a tag 6 into the tag holder 10, the tag holder 10 may be compressed between the top and bottom edges 24 and 26 to form a gap 40 therein, as illustrated in FIG. 3. The tag 6 may then be inserted into the gap 40 from the first or second edge 20 or 22, so that it is centred under the opening 18. Optionally, additional tags 6 may be positioned within the tag holder 10, as well, stacking a plurality of tags 6 together.

To secure the tag holder 10 to a pet collar 8, the mounting holes 30 and 32 are aligned with the collar holes 4, and a fastener 42, such as, by way of non-limiting example, a post and screw fastener, is passed through each mounting hole 30 and 32, and each aligned collar hole 4, as illustrated in FIG. 3. When the fasteners 42 are secured in place, the tag 6 is prevented from being removed from the tag holder 10, and the tag holder 10 is retained on the pet collar 8. It will be appreciated that such design will lie flush with the collar thereby increasing animal comfort and safety by reducing the risk of catching on external objects.

Turning now to FIG. 4, an optional embodiment of the present invention is illustrated wherein the front, rear and transparent planar members 12, 14 and 16 (14 and 16 not labelled on FIG. 4 for clarity) are formed to include one mounting hole, which may be secured with a fastener 42 to a pet collar 8 through an existing collar hole 4, without the need to punch additional holes in the pet collar 8. As illustrated in FIG. 4, the front, rear and transparent planar members 12, 14 and 16 are secured together proximate to the first and second edges 20 and 22, as well as proximate to the bottom edge 26. The tag holder 10 may be compressed between the first and second edges 20 and 22 to form a gap, into which the tag 6 may be inserted from the top edge 24. As illustrated in FIG. 4, the opening 18 may be cantered and sized to display the tag 6. The mounting hole is spaced apart from the stitching 28 (or other fastener method) proximate the bottom edge 26 such as to permit a tag 6 to be received therebetween.

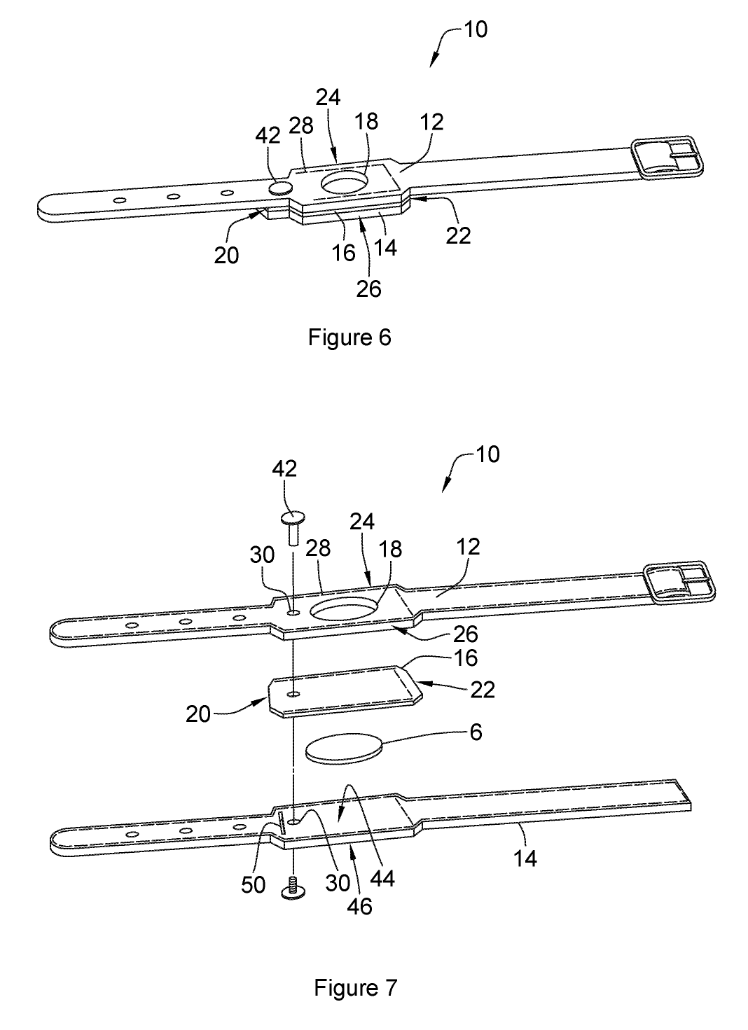

Turning now to FIG. 6, an optional embodiment of the present invention is illustrated wherein the tag holder 10 is co-formed with the pet collar. One such option includes the front planar member 12 extending to a full collar length and including a fastener, such as a buckle closure, as is commonly known. The collar extends from the first and second edges 20 and 22 of the front planar member 12, as illustrated in FIG. 6. The front, rear and transparent planar members 12, 14 and 16 are secured together proximate to the top and bottom edges 24 and 26, as well as proximate to the second edges 22 of the front and rear planar members 14 and 16 by any suitable method, such as, by way of non-limiting example, adhesives, stitching 28 (as illustrated), fasteners or the like. As illustrated in FIG. 6, the opening 18 is positioned to display the tag 6. In this optional embodiment, one fastener 42 secures the tag within the tag holder, as illustrated. It will be appreciated that the tag holder 10 may also be co-formed with the pet collar such that the rear planar member 14 is co-formed with the collar, extending to include a fastener, such as a buckle closure, rather than the front planar member 12, as illustrated.

Turning now to FIG. 7, a further embodiment of the present invention is illustrated wherein the tag holder 10 is co-formed with the pet collar. This option includes the front and rear planar members, 12 and 14, extending to a full collar length. The front planar member 12 includes a fastener, such as a buckle closure, as is commonly known. The collar extends from the first and second edges 20 and 22 of the front and rear planar members, 12 and 14, as illustrated in FIG. 7. The front, rear and transparent planar members 12, 14 and 16 are secured together proximate to the top and bottom edges 24 and 26, as well as proximate to the second edge 22 of the transparent planar member 16 by any suitable method, such as, by way of non-limiting example, adhesives, stitching 28 (as illustrated), fasteners or the like. In this optional embodiment, one fastener 42 secures the tag 6 within the tag holder 10. A slot 50 is formed in and extends through the rear planar member 14 between the front and rear surfaces, 44 and 46, respectively, proximate to the first edge 20, located between the first edge 20 and the mounting hole 30, and extending substantially between the fastener method, such as the illustrated stitching 28, proximate to the top and bottom edges 24 and 26. The slot 50 is sized to receive the tag 6 therethrough.

To secure a tag 6 within the tag holder 10 illustrated in FIG. 7, the tag 6 is passed from the rear 46 of the rear planar member 14 through the slot 50 and is positioned between the transparent planar member 16 and the front surface 44 of the rear planar member 14, centred below the opening 18 in the front planar member 12. Subsequently, the fastener 42 is secured through the mounting holes 30 thereby preventing the tag 6 from being removed from the tag holder 10 through the slot 50.

While specific embodiments of the invention have been described and illustrated, such embodiments should be considered illustrative of the invention only and not as limiting the invention as construed in accordance with the accompanying claims.

What is claimed is:

1. An apparatus for displaying and attaching a tag to a pet collar comprising:
a front planar member extending between first and second edges and between top and bottom edges;
a rear planar member extending between first and second edges and between top and bottom edges; and
at least one fastener for mounting said front and rear planar members to a pet collar,
wherein said front and rear planar members are sized to receive and contain the tag therebetween.

2. The apparatus of claim 1 wherein said front and rear planar members are flexible.

3. The apparatus of claim 2 wherein said front and rear planar members are formed of a material selected from a group consisting of leather, composite fabrics, and plastics.

4. The apparatus of claim 1 wherein said front planar member includes a display opening therethrough adapted to display the tag therethrough.

5. The apparatus of claim 1 wherein said front and rear planar members are joined to each other proximate to at least one of said first, second, top and bottom edges, wherein at least one edge is open.

6. The apparatus of claim 1 wherein said front and rear planar members include at least one mounting hole extending therethrough.

7. The apparatus of claim 6 wherein said at least one mounting hole comprises two mounting holes.

8. The apparatus of claim 7 wherein said two mounting holes are spaced apart by a distance sufficient to receive the tag therebetween.

9. The apparatus of claim 6 wherein said at least one mounting hole comprises one mounting hole at a location proximate to one of said first, second, top and bottom edges such that it is spaced apart a distance from an opposite edge to receive the tag therebetween.

10. The apparatus of claim 6 wherein said at least one fastener comprises screw and post fasteners.

11. The apparatus of claim 10 wherein said screw and post fasteners are passed through said at least one mounting hole.

12. The apparatus of claim 1 further includes a transparent planar member extending between said first and second edges and between said top and bottom edges, located between said front planar member and the tag.

13. The apparatus of claim 12 wherein said transparent member is secured to a rear surface of said front planar member.

14. The apparatus of claim 12 wherein said transparent planar member is formed of a material selected from a group consisting of plastic and acrylic.

15. An apparatus for displaying and attaching a tag to an animal comprising:
a collar, securable around the neck of an animal; and
at least one of the apparatus of claim 1.

16. The apparatus of claim 15 wherein said front planar member is co-formed with said collar.

17. The apparatus of claim 15 wherein said rear planar member is co-formed with said collar.

18. The apparatus of claim 17 wherein said rear planar member includes a slot therethrough adapted to allow the tag to pass therethrough;

19. The apparatus of claim 18 wherein said slot is formed at a location proximate to one of said first, second, top and bottom edges such that it is spaced apart a distance from an opposite edge to receive the tag therebetween.

20. A method for displaying and attaching a tag to a pet collar comprising:
providing a front planar member extending between first and second edges and between top and bottom edges;
providing a rear planar member extending between first and second edges and between top and bottom edges;
inserting the tag between said front and rear planar members;
fastening said front and rear planar members to a pet collar so as to contain the tag therebetween.
